(19) United States
(12) Patent Application Publication
(10) Pub. No.: US 2002/0126206 A1
(43) Pub. Date: Sep. 12, 2002

(54) Electronic side--view mirrors for motor vehicles using exterior cameras wired to interior monitor

(76) Inventor: Stanley G. Hunte, Chicago, IL (US)

Correspondence Address: Stanley G. Hunte, 4456 N. KENTON AVENUE, Chicago, IL, 60630, US

(21) Appl. No.: 09/754,417

(22) Filed: Jan. 5, 2001

(51) Int. Cl. H04N 7/18

(52) U.S. Cl. 348/148; 348/159

(57) ABSTRACT

A side-viewing accessory for road motor vehicles, being two wide-angle cameras affixed to front fenders of said vehicles, electrically connected to transmit electronic signals to monitor screen mounted on dashboard. Monitor being either single-vision having knob switch for viewing left side and right side sequentially, or said monitor being dual-vision that views both left and right sides of landscape behind the travelling vehicle, side by side on the screen simultaneously. Said cameras recessed in aerodynamic housings, and monitor situated inside the vehicle, precludes poor visibility from elements of weather. A radar capability is claimed to warn when following vehicles draw up alongside. And also claimed is a rear view mirror having a convex shaped longitudinal aspect to broaden side viewing capability in the event of electrical or mechanical failure of the said accessory.

### BACKGROUND OF THE INVENTION

Millions of motor vehicles have two external Side-view Mirrors affixed to each side of the vehicle, projecting six or more inches, by which the driver views following traffic. These side-view mirrors sometimes cause collisions with stationary objects or are damaged by passing objects, or when doors of a parked car are unexpectedly pushed open. These mirrors are unable to show a vehicle that is following slightly behind the driver's seat, and this ‘blind-spot’ contributes to many road accidents. Furthermore, the exterior mirrors and the adjacent glass windows become clouded over when there is rain or snow; and internal condensation makes viewing the mirrors impossible at times. This novel Invention is designed to solve all such problems and provide additional features.

The projecting mirrors will be replaced by two small electronic wide-angle cameras mounted on the front fenders on each side over the front wheels where the body width of the vehicle is greatest; and will be electrically wired to a video screen on the dashboard. This will provide the driver with full visibility of all following traffic on both the left and right sides of the road. The images from the cameras will be electronically transmitted, either to a dual-vision monitor that shows the two pictures, side by side, at the same time; or to a mono-vision monitor that features a knob switch to view either side as required. The monitor may be installed ‘indash’ or mounted on the dashboard ledge. The monitor will be positioned to face towards the driver.

The recessed cameras will be shielded from the elements of the weather by aerodynamic housings bolted to the underside of the fenders of existing vehicles, or molded into the bodies of new vehicles. Electrical power will be provided by the vehicle's 12-volt grid.

The apparatus envisioned under this invention would be produced by engineers and manufacturers specializing in electronic technology of prior art, and will be attachable to all existing vehicles as an accessory. Makers of new vehicles will be enabled to install the apparatus covered by this invention as standard equipment on models of the future. This invention also includes using infrared cameras for night viewing for specific markets, such as the Military.

In case of electrical or mechanical failure, this invention provides for the conventional flat-glass rear-view mirror to be replaced by a convex shaped mirror to provide wide side-view visibility by natural viewing.

A further enhancement is claimed by this invention for a radar capability of prior art that will cause a beeping signal when any following vehicle is alongside the driver's vehicle.

### BRIEF DESCRIPTION OF THE DRAWINGS

FIG. 1 is a perspective view of a modern motor car <1> with the aerodynamic housing <2> containing the wide-angle camera affixed to the left front fender,<3> serving to demonstrate the positioning according to the present invention.

FIG. 2 is a perspective view of the right side of a motor vehicle <1> with camera housing <2> shown, affixed to the right front fender,<4> similar to FIG. 1.

FIG. 3 is a plan view <5> of a motor vehicle illustrating the two camera housings <2> affixed to the widest part of the body,<6> and the sight lines of the wide-angle camera lens. <7> The position of the monitor screen <14> in the dashboard area <8> is also illustrated. The locations to the side of the vehicle where the radar signal will be activated is shown <18>.

FIG. 4 is a fragmentary back view <9> of a motor vehicle illustrating the dual-vision monitor screen <10> mounted on the dashboard frame. Also seen are the two conventional side mirrors, <12> which will not be needed according to the present invention. The convex shaped rear-view mirror <19> is also shown.

FIG. 5 and FIG. 5A show a perspective view of the recessed camera <13> and the aerodynamic housing <2>, with flange <11>, that is bolted to the left and right front fenders, <3,4> according to the present invention. The overall size of the housing <2> containing the camera is approximately 3 inches in length and 1 inch in width.

FIG. 6 and FIG. 6A are perspective views of the monitor screen, <14> using CRT technology, being mono-vision <15> and dual-vision <10> monitors using LCD technology that are mounted on the dashboard ledge of the vehicle according to the present invention.

FIG. 7 is a plan view of the convex rear-view mirror <19> attached to the front windshield.

FIG. 8 Shows the broad-spectrum area viewable by means of a convex rear-view mirror, to the rear and two sides of the vehicle.

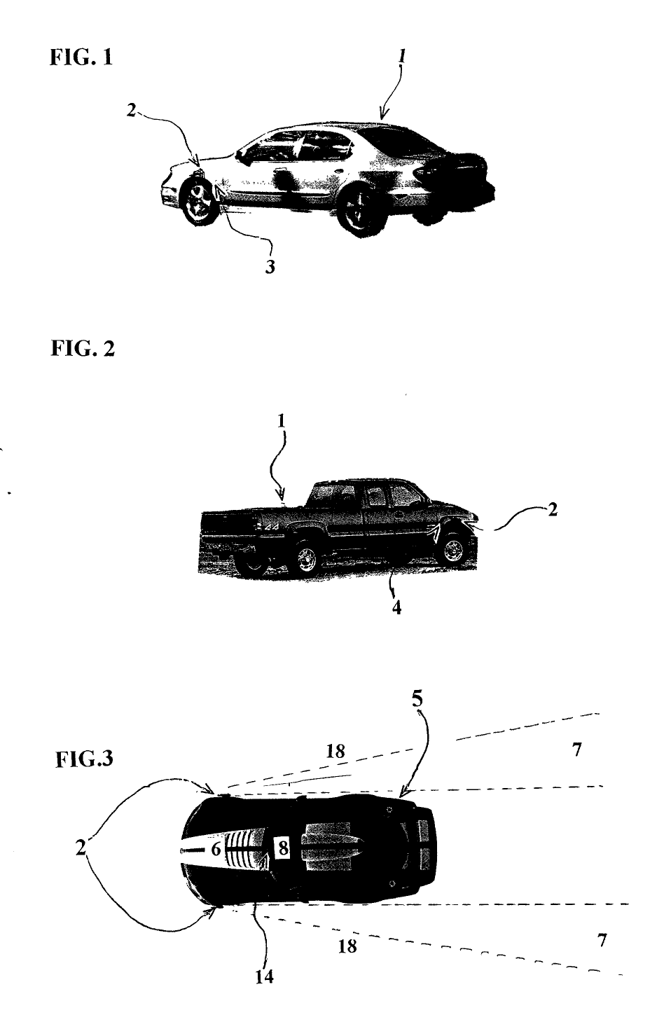

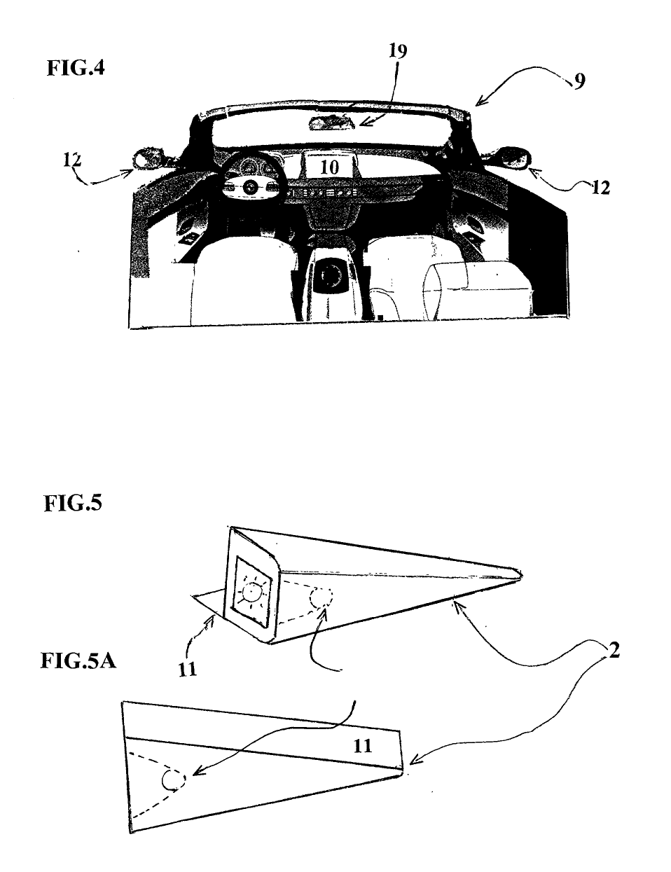

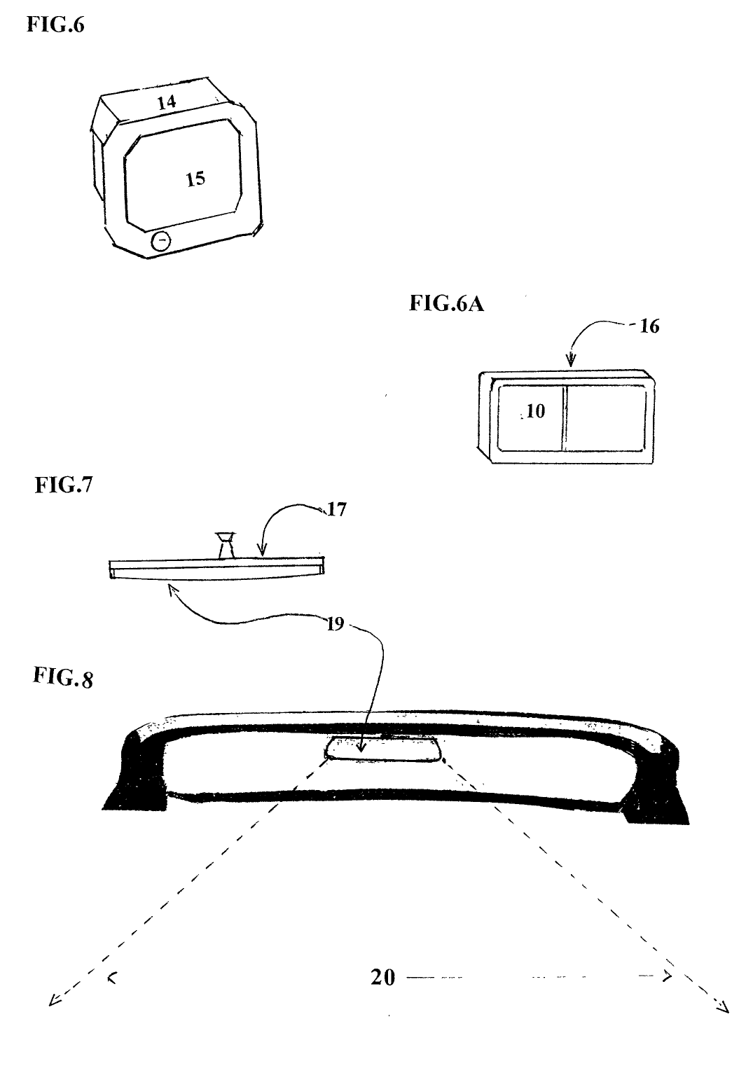

### CROSS-REFERENCES OF NUMBERED SECTIONS OF DRAWINGS

| <>numbered references | | Fig.Ref |
|---|---|---|
| 1 | Motor vehicle | 1,2, |
| 2 | Aerodynamic housing | 1,2,3, 5 |
| 3 | Left front fender | 3,5 |
| 4 | Right front fender | 2, 5 |
| 5 | Plan View of motor vehicle | 3 |
| 6 | Widest section of vehicle body | 3 |
| 7 | Wide angle camera sight lines | 3 |
| 8 | Dashboard | 3 |
| 9 | Back view of vehicle | 4 |
| 10 | Dual vision monitor screen | 4 |
| 11 | Flange for bolting to Fenders | 5,5A |
| 12 | Conventional side mirrors | 4 |
| 13 | Recessed camera | 5 |
| 14 | CRT monitor screen | 6 |
| 15 | Mono-vision monitor | 6 |
| 16 | LCD dual-vision monitor | 6A |
| 17 | Single rear-view convex mirror | 7 |
| 18. | Radar signal activation areas | 3 |
| 19. | Rear-view Convex mirror | 7,8 |
| 20. | Wide spectrum of convex mirror | 8 |

### GENERAL DESCRIPTION

The “Electronic Side-view mirrors for motor vehicles using exterior cameras wired to interior monitor” describes the Invention of a novel accessory for the automotive world.

For the first time manufacturers of new motor vehicles, whether the larger vehicles, or the smaller passenger cars, will have a means of enhancing the safety factor of their vehicles on the roads. And owners of existing models of all types of road vehicles will have the option to install the main components of the apparatus envisaged under this Invention, which will become available at Auto Parts retail shops in due course. The components are: (1) the two aerodynamic housings containing the small wide-angle Electronic Cameras, and radar emitters, for bolting to the front fenders; and (2) the dual-vision or mono-vision video-monitor screen for mounting atop the dashboard ledge inside the vehicle, or ‘in dash’.

The conventional projecting exterior side-view mirrors mounted on each side of the vehicle will become unnecessary or even obsolete by this new invention.

The camera housings could be fitted with infrared cameras in addition to the daylight cameras, for specialized markets. And a radar capability could be included to cause a signal to sound when a following vehicle comes alongside the leading vehicle.

Because the mirrors are placed nearer the front of the vehicle than the conventional mirrors, and because the wide-angle lens will cover a broader spectrum, the ‘blind-spot’ hazard will be eliminated, or a least diminished. Because electronic technology is advancing at such a rapid pace, it is difficult to embrace every development in this description. For example, It is now reported that General Motors is developing a system to have the speedometer information projected onto the windshield, so that it may be seen from a ‘heads-up’ position. And similarly the radio station that is tuned into would be visible on the windshield glass. It would be possible therefore to have the pictures transmitted by the two cameras to be projected on to the windshield, to avoid looking down on the dashboard to see the video-screen, if such technology ever became available.

In the event of electronic or mechanical failure of the apparatus invented hereunder, the single rear-view mirror affixed to the vehicle windshield would have a convex-shaped aspect to broaden the side spectrum view, in the absence of the traditional side-view mirrors.

What is claimed is:

1. An apparatus, being an electronic accessory for motor vehicles traveling on roadways, providing drivers with pictures of the landscape behind each side of the said vehicles, including following traffic, using electronic closed circuit TV technology of prior art
comprising two wide-angle electronic cameras attachable to fenders over the front wheels of said motor vehicles at points where the body of said vehicles is widest,
said cameras being electrically wired to a monitor screen incorporated into the dashboard of new vehicles or mounted thereon of existing models, positioned to be visible to drivers of said vehicles.
said cameras recessed and shielded from elements of the weather being encased in aerodynamic housings with the camera lens facing towards the rear of said vehicles.
said aerodynamic housings are tapered to the front to reduce wind resistance having dimensions of approximately three inches in length and one inch in width.
said aerodynamic housing to also contain an infrared wide-angle camera for purpose of night-time use.

2. An apparatus as defined in claim 1, wherein an electronic accessory for motor vehicles traveling on roadways, providing drivers with pictures of the landscape behind each side of the said vehicles, including following traffic
comprising two electronically activated wide-angle cameras wired to a TV type mono-vision monitor screen,
said two cameras mountable on left side and on right side of front-wheel fenders of motor vehicles, said cameras facing towards rear of said vehicle,
said mono-vision monitor screen installed on dashboard ledge of said vehicle;
said monitor screen having switch control to receive images from left side camera and right side camera by means of manually operated knob switch mounted on said monitor, or mounted on steering column of said motor vehicle.

3. An apparatus as defined in claim 1, wherein an electronic accessory for motor vehicles traveling on roadways, providing drivers with pictures of the landscape behind each side of the said vehicles, including following traffic
comprising two electronically activated wide-angle cameras wired to a TV type dual-vision monitor screen,
said dual-vision video monitor screen having the left half of said monitor screen electronically wired to said camera mounted on left side of said vehicle; and the right side of said monitor screen wired to the camera on the right side of said vehicle.
said dual-vision screen showing side-views of both left side and right side of vehicle at the same time without necessity of knob control switching.

4. An apparatus as defined in claim 2 and 3, wherein an electronic accessory for motor vehicles traveling on roadways, providing drivers with pictures of the landscape behind each side of the said vehicles, including following traffic
comprising two electronically activated wide-angle cameras wired to TV type dual-vision screen or wired to mono-vision screen,
said cameras equipped with radar capability to cause an audible signal to sound when a following vehicle comes alongside either side of the leading vehicle.

5. An apparatus as defined in claim 1, wherein an electronic accessory for motor vehicles traveling on roadways, providing drivers with pictures of the landscape behind each side of the said vehicles, including following traffic
comprising two electronically activated wide-angle cameras wired to a TV type monitor screen
said motor vehicle so equipped as above to have a convex rear-view mirror attached to windshield to provide manual viewing of a wide spectrum in case of electronic failure of the apparatus invented hereunder.
